(19) United States
(12) Patent Application Publication
(10) Pub. No.: US 2024/0411030 A1
(43) Pub. Date: Dec. 12, 2024

(54) METHOD AND DEVICE FOR CALIBRATING GNSS ANTENNA

(71) Applicant: Samsung Electronics Co., Ltd., Suwon-si (KR)

(72) Inventors: Bogeun Cho, Suwon-si (KR); Changdon Kee, Seoul (KR); Jongheon Kim, Seoul (KR); Bugyeom Kim, Seoul (KR)

(73) Assignees: Samsung Electronics Co., Ltd., Suwon-si (KR); Seoul National University R&DB Foundation, Seoul (KR)

(21) Appl. No.: 18/422,593

(22) Filed: Jan. 25, 2024

(30) Foreign Application Priority Data
Jan. 25, 2023 (KR) 10-2023-0009546
May 17, 2023 (KR) 10-2023-0063799

(51) Int. Cl. G01S 19/23; G01S 19/07; H04B 17/21

(52) U.S. Cl. CPC G01S 19/235; G01S 19/07; H04B 17/221

(57) ABSTRACT

A method of calibrating a global navigation satellite system (GNSS) antenna includes obtaining GNSS measurement data corresponding to a plurality of directions that correspond to a plurality of respective postures of the electronic device, generating integration data by combining the GNSS measurement data corresponding to the plurality of directions, and performing calibration of the GNSS antenna based on the integration data.

### CROSS-REFERENCE TO RELATED APPLICATION

This application is based on and claims priority under 35 U.S.C. § 119 to Korean Patent Application Nos. 10-2023-0009546, filed on Jan. 25, 2023, and 10-2023-0063799, filed on May 17, 2023, in the Korean Intellectual Property Office, the disclosures of which are incorporated by reference herein in their entireties.

### BACKGROUND

Aspects of the inventive concept relate to a calibration method and device, and more particularly, to a method and device for calibrating a global navigation satellite system (GNSS) antenna.

A satellite navigation system is currently used as a basic navigation system in various fields for airplanes, ships, drones, and smartphones. In particular, the market for consumer services such as smartphones and tablets is expanding due to the increase in position-based services and applications. Most customer services using a satellite navigation system are smartphone users, and also include users of sports wearables or digital cameras. In this regard, low-cost products are used for satellite navigation receivers embedded in devices for price competitiveness.

A signal collection position of a GNSS antenna differs depending on a direction in which a signal is received. When the difference of the signal collection position is not compensated for, because a user position is determined differently from an actual user position, it is often necessary to estimate and compensate for the signal collection position according to the direction of the received signal. In the case of GNSS antennas of the related art, GNSS antenna calibration is performed by using an expensive robot arm or calibration software. Alternatively, in the absence of expensive external equipment, calibration is performed in one direction only. This is because GNSS antennas in the related art are fixed and collect measurements only in the sky direction (e.g., a direction above the antenna with respect to the ground being below the antenna).

However, a smartphone is used in various postures while being held in a user hand, and receives signals in all directions thereof because an ultra-small and ultra-low-cost antenna is mounted on the smartphone. Therefore, an antenna of a smartphone needs calibration to estimate and compensate for a signal collection position in all directions in which the phone may be oriented.

### SUMMARY

Aspects of the inventive concept provide a method and device for performing calibration of a global navigation satellite system (GNSS) antenna in all directions.

According to an aspect of the inventive concept, a method of calibrating a global navigation satellite system (GNSS) antenna includes obtaining GNSS measurement data corresponding to a plurality of directions that correspond to a plurality of respective postures of the electronic device, generating integration data by combining the GNSS measurement data corresponding to the plurality of directions, and performing calibration of the GNSS antenna based on the integration data.

According to another aspect of the inventive concept, an electronic device includes a GNSS antenna configured to receive satellite signals, a GNSS module including a calibration module configured to perform calibration of the GNSS antenna, and a sensor module configured to obtain sensing data about a posture of the electronic device, and the calibration module may be configured to obtain GNSS measurement data corresponding to a plurality of directions that correspond to a plurality of respective postures of the electronic device, generate integration data by combining the GNSS measurement data corresponding to the plurality of directions, and perform calibration of the GNSS antenna based on the integration data.

According to another aspect of the inventive concept, a method of calibrating a GNSS antenna includes generating first measurement data by receiving a signal when the antenna is in a posture inclined in a first direction, generating second measurement data by receiving a signal when the antenna is in a posture inclined in a second direction different from the first direction, generating integration data by combining the first measurement data with the second measurement data, and performing calibration of the GNSS antenna based on the integration data.

### BRIEF DESCRIPTION OF THE DRAWINGS

Embodiments will be more clearly understood from the following detailed description taken in conjunction with the accompanying drawings in which:

FIG. 1 is a block diagram illustrating an electronic device according to an embodiment;

FIG. 2 is a flowchart illustrating an operating method of an electronic device according to an embodiment;

FIG. 3 is a flowchart illustrating detailed operations of an operation of integrating measurement data according to an embodiment;

FIG. 4 illustrates an example of an electronic device receiving satellite signals in first to third postures according to an embodiment;

FIG. 5 illustrates an example of integrating measurement data according to an embodiment;

FIG. 6A is an example of three-dimension (3D) transformation of a signal received by an electronic device in a first posture according to an embodiment;

FIG. 6B is an example of 3D transformation of a signal received by an electronic device in a second posture according to an embodiment;

FIG. 6C is an example of 3D transformation of a signal received by an electronic device in a third posture according to an embodiment;

FIG. 6D is an example of 3D transformation through integration of measurement data according to an embodiment;

FIG. 7 is a flowchart illustrating detailed operations of an antenna calibration operation according to an embodiment;

FIG. 8 illustrates a reference position, an average position, and a phase center variation (PCV) model according to an embodiment; and

FIGS. 9A and 9B are graphs illustrating improvement of calibration reception performance according to an embodiment.

### DETAILED DESCRIPTION OF THE EMBODIMENTS

Hereinafter, embodiments of the inventive concept will be described in detail with reference to the accompanying drawings.

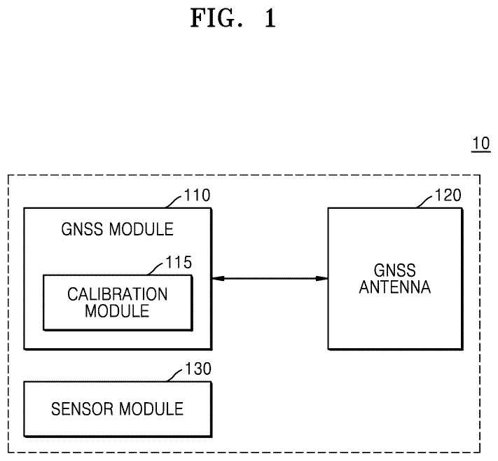

FIG. 1 is a block diagram illustrating an electronic device 10 according to an embodiment.

Referring to FIG. 1, the electronic device 10 may include a global navigation satellite system (GNSS) module 110, a GNSS antenna 120, and a sensor module 130.

The electronic device 10 may be a device using a satellite navigation system for accurate positioning of the device itself. For example, the electronic device 10 may be a device such as a smart phone, a tablet personal computer (PC), a laptop PC, or a wearable device. However, the electronic device 10 of the inventive concept is not limited thereto, and may include any devices including a GNSS module and a GPS module, particularly devices that are portable and can easily change orientation.

According to an embodiment, the GNSS module 110 may measure a position of the electronic device 10 based on the satellite navigation system. The GNSS module 110 may obtain a distance difference between the electronic device 10 including the GNSS module 110 and each of at least four satellites based on signals received from the at least four satellites, and may determine an accurate position of the electronic device 10 including the GNSS module 110 by using triangulation based on the obtained distance difference.

According to an embodiment, the GNSS module 110 may further include a calibration module 115. The calibration module 115 may perform calibration so that all satellite signals are received at the same position by calibrating an error of an actual reception position according to a direction in which a satellite signal is received. The calibration module 115 may calculate and store a plurality of calibration values for all directions in which satellite signals may be received based on phase center variation (PCV) model information. For example, the calibration module 115 may calibrate a satellite signal received from a first direction by adjusting the signal according to a first vector, and calibrate a satellite signal received from a second direction by adjusting the signal according to a second vector.

As is traditional in the field of the disclosed technology, features and embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

According to an embodiment, the GNSS antenna 120 may receive GNSS signals from a plurality of satellites. For example, the GNSS antenna 120 may receive GNSS signals from at least four satellites, respectively. According to some embodiments, the GNSS antenna 120 may be implemented with various types of antennas including a dipole antenna, a monopole antenna, a patch antenna, and a slot antenna.

According to an embodiment, the sensor module 130 may obtain sensing data about a posture of the electronic device 10. For example, the sensor module 130 may be an inertial measurement unit (IMU) sensor. The sensor module 130 may be a module including a gyro sensor, an acceleration sensor, and a geomagnetic sensor. Sensor data obtained by the sensor module 130 may be data used to virtually rotate the electronic device 10 receiving satellite signals in various postures to match one reference frame.

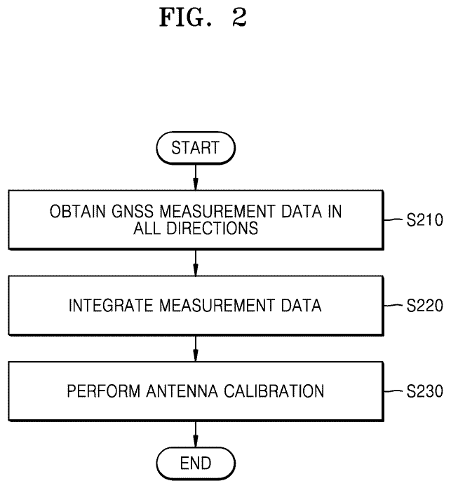

FIG. 2 is a flowchart illustrating an operating method of the electronic device 10 according to an embodiment.

Referring to FIG. 2, in operation S210, the electronic device 10 is configured to obtain GNSS measurement data in all directions. For example, the electronic device 10 may receive satellite signals received from a plurality of directions by using the GNSS antenna 120 in various orientations of the electronic device 10.

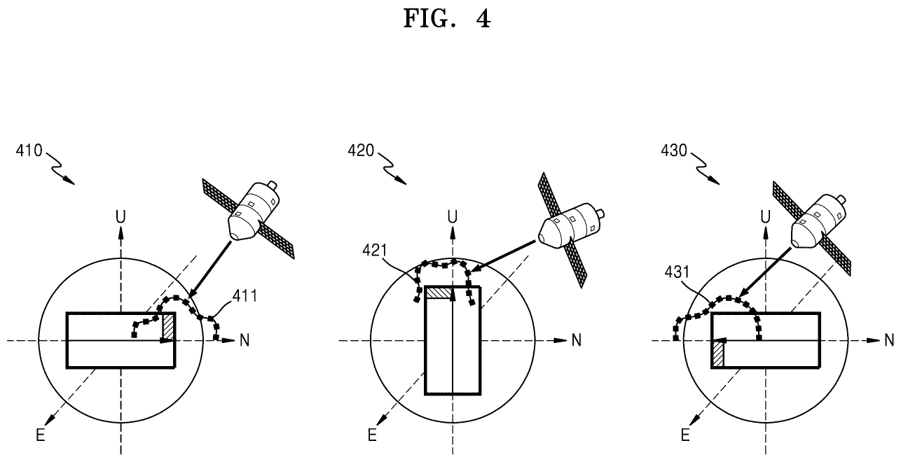

Referring to FIG. 4 together with FIG. 2, according to an embodiment, the electronic device 10 may receive satellite signals in a first posture 410. Though only a single satellite is shown in FIG. 4, the signals received at the electronic device 10 would be received from a plurality of satellites (e.g., 3 or 4). It may be assumed that the GNSS antenna 120 is provided on an upper portion of the electronic device 10. Satellite signals actually received by the GNSS antenna 120 included in the electronic device 10 in the first posture 410 may be the same as IPCs 411 (e.g., the combined satellite signal may have a shape profile or waveform such as shown by diagram 411). The IPC refers to Instant Phase Center. A PCV (Phase Center Variation) would be generated because IPCs may be varied based on a frequency of satellite signal, an azimuth angle, and a zenith angle. The electronic device 10 may receive satellite signals in a second posture 420. Satellite signals actually received by the GNSS antenna 120 included in the electronic device 10 in the second posture 420 may be the same (e.g., have the same shape profile or waveform) as IPCs 421. The electronic device 10 may receive satellite signals in a third posture 430. Satellite signals actually received by the GNSS antenna 120 included in the electronic device 10 in the third posture 430 may be the same (e.g., have the same shape profile or waveform) as IPCs 431. Therefore, over a period of time during a calibration process, the electronic device 10 may receive three different IPCs in three different postures.

In this manner, the electronic device 10 may obtain GNSS measurement data in all directions with respect to the electronic device by receiving satellite signals while changing only the posture of the electronic device 10 at the same positions as the first posture 410 to the third posture 430. Only the first posture 410 to the third posture 430 are shown in FIG. 4, but it will be apparent that the posture of the electronic device 10 may be changed in various ways three-dimensionally (3D) in order to receive satellite signals in all directions.

In operation S220, the electronic device 10 may integrate the measurement data. Integrating the measurement data may refer to integrating the IPCs 411 to 431 (FIG. 4) of the satellite signals received in different directions in three-dimensional space into 3D IPCs with respect to the electronic device 10 by transforming the GNSS measurement data obtained in various postures into one reference posture (hereinafter referred to as a reference frame).

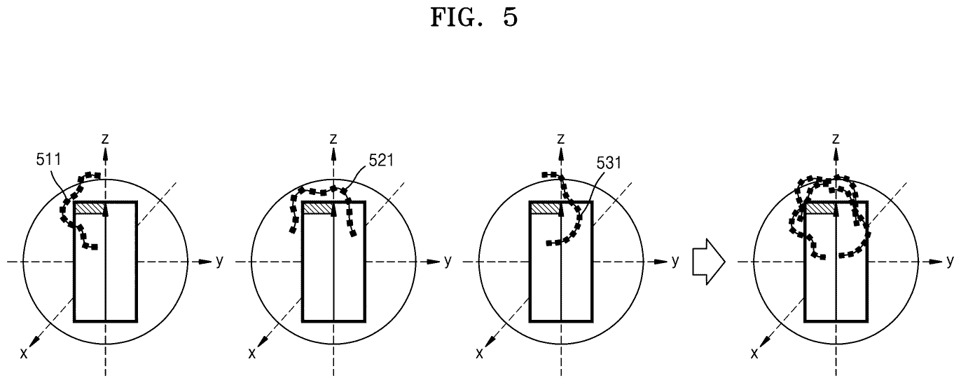

Referring to FIG. 5 together with FIGS. 2 and 4, the electronic device 10 postures in the first posture 410 to the third posture 430 of FIG. 4 are aligned according to the reference frame. According to an embodiment, the reference frame may correspond to the second posture 420 of FIG. 4. The electronic device 10 may rotate the IPCs 411 obtained in the first posture 410 to match when changed to the second posture 420 in order to integrate the measurement data. For example, IPCs 511 may be obtained by rotating the IPCs 411 in the first posture 410 by 90 degrees in a counterclockwise direction with respect to a plane having the X-axis as a normal line. The electronic device 10 may rotate the IPCs 431 obtained in the third posture 430 to match when changed to the second posture 420 in order to integrate the measurement data. For example, IPCs 531 may be obtained by rotating the IPC 431 in the third posture 430 clockwise by 90 degrees with respect to a plane having the X-axis as a normal line. The electronic device 10 may integrate the measurement data by merging the IPCs 511, 521, and 531. These steps may be performed, for example, by a processor of the electronic device 10 in communication with the other components of the electronic device (e.g., the GNSS antenna 120, sensor module 130, etc.).

In operation S230, the electronic device 10 may perform antenna calibration. The antenna calibration may correspond to generating a PCV model for correcting errors of satellite signals received in all directions. The PCV model indicates how satellite signals received in respective directions are distributed based on an average reception point. The PCV model may be, for example, a spherical harmonics function. However, the PCV model is not limited to the spherical harmonics function based on a spherical coordinate system, and may include any functions for modeling a 3D structure. For example, the PCV model may include any models which are based on a grid concept such as voxel modeling.

The electronic device 10 may be programmed to know that a satellite signal received in a first direction is spaced apart from the average reception point by a first vector based on the PCV model. When the satellite signal is received in the first direction based on the PCV model, the electronic device 10 may calibrate the received satellite signal in a direction opposite to the first vector such that a reception position of the received satellite signal is located at the average reception point.

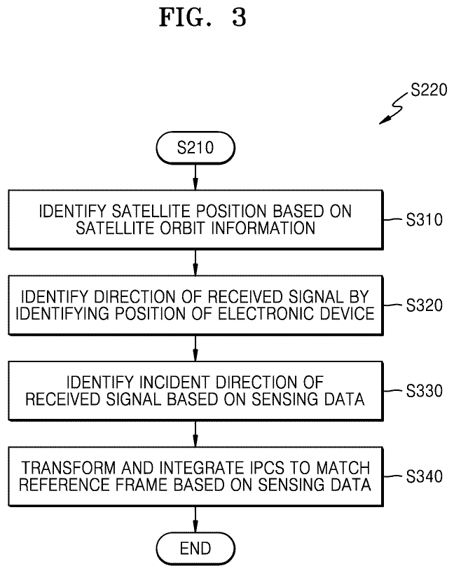

FIG. 3 is a flowchart illustrating detailed operations of operation S220 of integrating measurement data according to an embodiment.

Referring to FIG. 3, in operation S310, the electronic device 10 may identify a satellite position based on satellite orbit information. The satellite orbit information is information for identifying a position of a satellite, and may be a broadcast ephemeris. The broadcast ephemeris may correspond to satellite orbit information broadcast in real time. For example, the satellite orbit information may be almanac information including rough orbit parameter information of satellite arrangement.

In operation S320, the electronic device 10 may identify a direction of a received signal by identifying a position of the electronic device 10. In this regard, the position of the electronic device 10 may represent a coordinate value on an earth-centered earth fixed frame (ECEF) coordinate system. The ECEF coordinate system has the center of gravity of the earth as its origin and is a coordinate system used in satellite navigation. The position of the electronic device 10 may be known in advance, or may be determined using a system other than the satellites from which the signals are being received. The electronic device 10 may identify directions in which satellite signals transmitted respectively by a plurality of satellites are received by synthesizing a coordinate value indicating the position of the electronic device 10 on the ECEF coordinate system and the satellite orbit information.

In operation S330, the electronic device 10 may identify an incident direction of the received signal based on sensing data. For example, even when the electronic device 10 exists at the same position on the ECEF coordinate system and the same satellite orbit transmits the satellite signals, angles (or directions) at which the satellite signals are incident to the electronic device 10 may be different depending on a posture of the electronic device 10. The electronic device 10 may identify directions in which the satellite signals are incident to the electronic device 10 based on the position of the electronic device 10 on the ECEF coordinate system, the broadcast ephemeris, and an inclined posture of the electronic device 10. Therefore, when the electronic device 10 changes the directions in which the satellite signals are incident to the electronic device 10 by changing inclined angles according to various postures, the same effect as receiving satellite signals in all directions may be achieved.

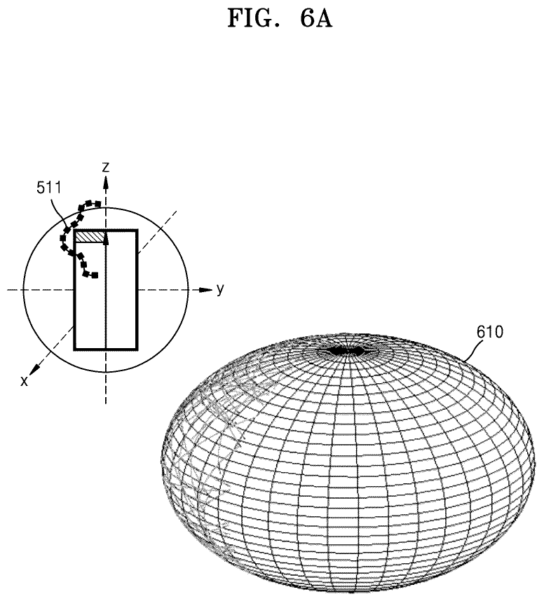

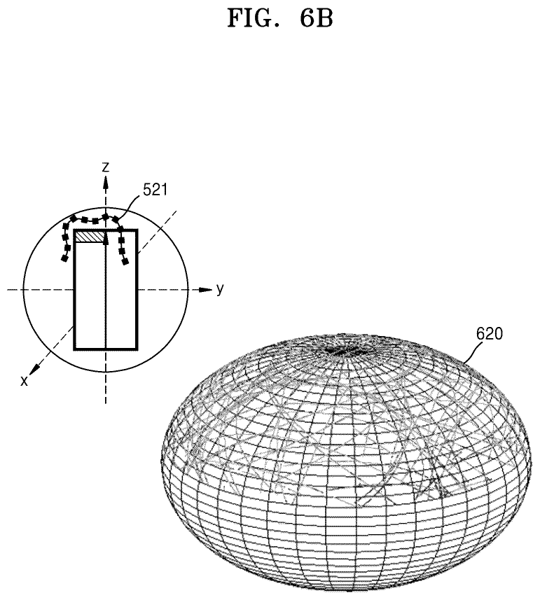

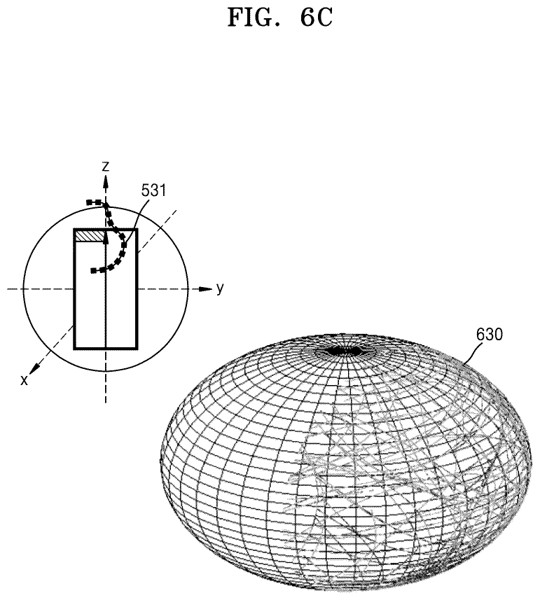

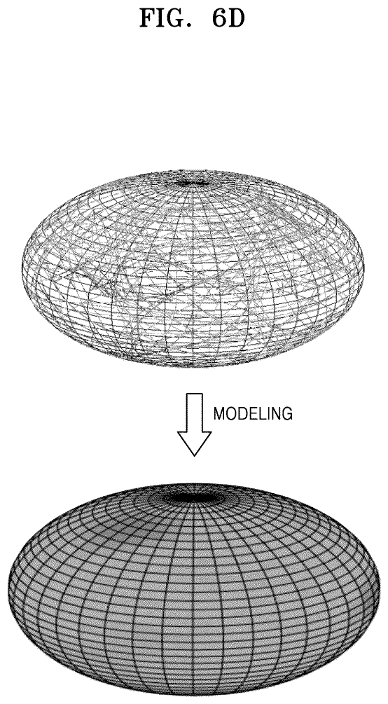

In operation S340, the electronic device 10 may transform and integrate IPCs to match a reference frame, based on the sensing data. Referring to FIG. 5 together with FIG. 3, because the second posture 420 is the reference frame, the IPCs 421 obtained in the second posture 420 may not be necessarily transformed. The electronic device 10 may obtain the IPCs 511 by rotating the IPCs 411 in the first posture 410 in a counterclockwise direction by 90 degrees with respect to a plane having the X-axis as a normal line. The electronic device 10 may obtain the IPCs 531 by rotating the IPCs 431 in the third posture 430 in a clockwise direction by 90 degrees with respect to a plane with the X-axis as a normal line. The electronic device 10 may integrate measurement data by merging the IPCs 511, 521, and 531. The integrated measurement data may represent actual received signals when the electronic device 10 receives satellite signals, from the same group of satellites, in various orientations of the electronic device 10, and then combines those signals. Referring to FIGS. 6A to 6C, when the IPCs 511 are 3D transformed into an ECEF coordinate system, the IPCs 511 may be expressed in relation to a sphere 610. When the IPCs 521 are 3D transformed into the ECEF coordinate system, the IPCs 521 may be expressed in relation to a sphere 620. When the IPCs 531 are 3D transformed into the ECEF coordinate system, the IPCs 531 may be expressed in relation to a sphere 630. When signals received respectively in the first posture 410 to the third posture 430 are rotated to match the reference frame, and the IPCs 511 to 531 are integrated on the ECEF coordinate system, the IPCs 511 to 531 may be expressed in relation to a sphere 640.

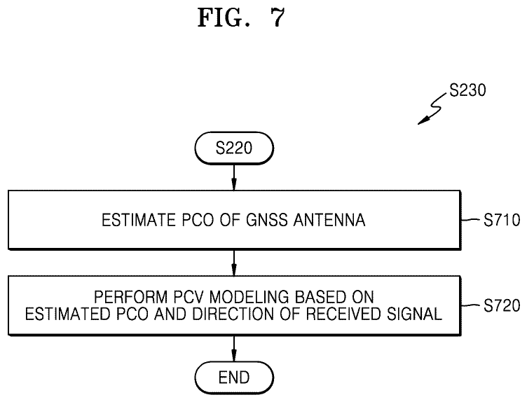

FIG. 7 is a flowchart illustrating detailed operations of antenna calibration operation S230 according to an embodiment.

Referring to FIG. 7, in operation S710, the electronic device 10 may estimate a phase center offset (PCO) of the GNSS antenna 120. The PCO may indicate a difference between an average position at which satellite signals are received and a reference position.

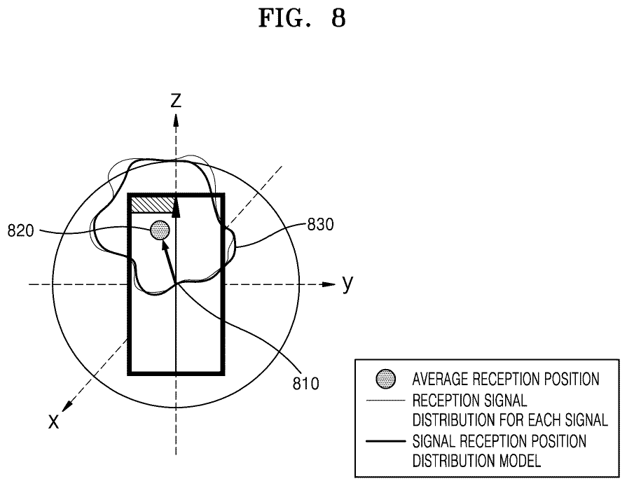

Referring to FIG. 8 together with FIG. 7, the reference position may be a first point 810. In FIG. 8, the first point 810 is set to correspond to ae 3D center of the electronic device 10, but is not limited thereto. According to some embodiments, the reference position may be an upper center point or a lower center point of the electronic device 10, and is not limited to a specific position. For example, when antenna reference point (ARP) information is known, the reference position may be the ARP.

Referring to FIG. 8 together with FIG. 7, the average position may be a second point 820. The second point 820 may correspond to a coordinate that is an average of the IPCs 511 to 531 that have been transformed into reference frames and integrated. Alternatively, the second point 820 may be an average coordinate of the sphere 640 integrated on an ECEF coordinate system. The electronic device 10 may estimate a difference between the first point 810 and the second point 820 as the PCO.

In operation S720, the electronic device 10 may perform PCV modeling based on the estimated PCO and a direction of a received signal. When the electronic device 10 receives a satellite signal and calibrates the estimated PCO with respect to a distance estimated by the received satellite signal, all signals may be considered to be received at the second point 820. However, even in this case, an error according to a reception direction may still exist.

The electronic device 10 may compensate for the received signal by using the estimated PCO and generate a PCV model according to the reception direction. The electronic device 10 may obtain spherical harmonics (SH) coefficients by applying an equation of SH modeling to a signal calibrated by using the PCO with respect to the received signal. The SH coefficients may correspond to the PCV model. Referring to FIG. 8, the PCV model may correspond to a closed curved surface 830.

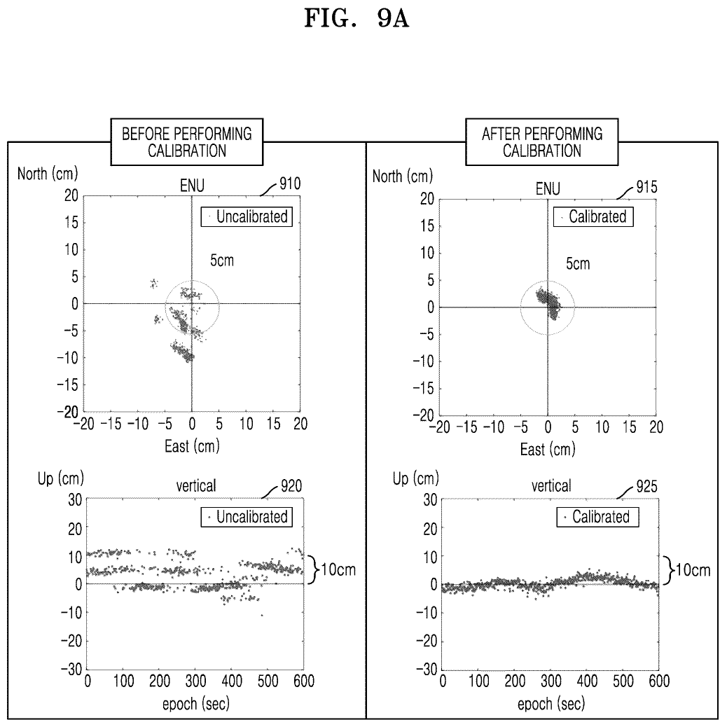

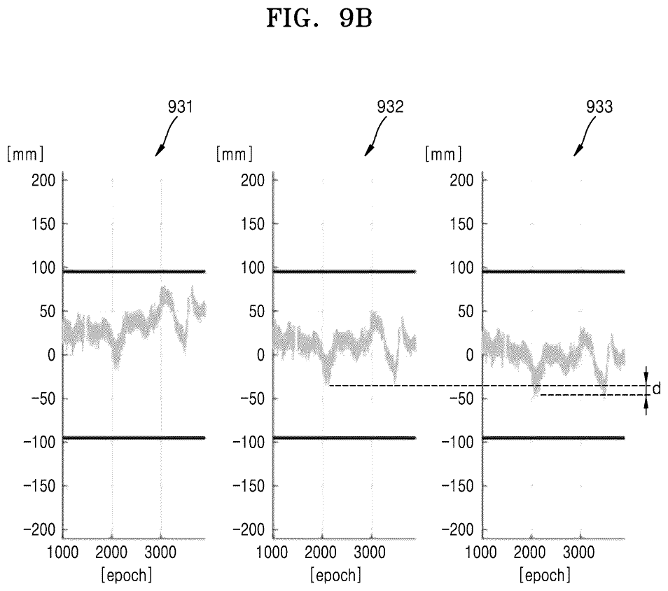

FIG. 9A is a graph illustrating improvement of calibration reception performance according to an embodiment.

Referring to FIG. 9A, graphs 910 and 920 show signals received before performing GNSS antenna calibration according to an embodiment. The graph 910 shows the signals received before calibration on an cast north up (ENU) coordinate system. At the same time, the graph 920 shows how much the signals received before calibration, that is, the signals of the graph 910, are distributed and received in a vertical direction from the origin over time. Referring to a graph 915, after performing GNSS calibration according to an embodiment, the electronic device 10 may previously store PCO and PCV models. The electronic device 10 may calibrate a distance by a PCO with respect to a received satellite signal, subtract a vector value corresponding to a reception direction of the PCV model from the received satellite signal, and adjust signals received from all directions to a reference position. Accordingly, it may be seen that the signals received on the graph 915 are concentrated at the reference position (the origin). Referring to a graph 925, it may be seen that signals received after calibration, that is, the signals of the graph 920, are not distributed and received in the vertical direction from the origin after calibration, but are received densely on the X axis (vertical direction=0).

FIG. 9B is a graph illustrating improvement of calibration reception performance according to an embodiment.

Referring to FIG. 9B, a first graph 931 to a third graph 933 are shown. The X-axis of each of the first graph 931 to the third graph 933 represents a time flow, and the Y-axis represents an error magnitude of a received signal.

According to an embodiment, the first graph 931 shows the error magnitude based on a signal received before calibration. Referring to the first graph 931, it may be seen that the error magnitude tends to increase over time.

According to an embodiment, the second graph 932 shows the error magnitude based on a signal received at an intermediate point of calibration. For example, the second graph 923 shows the error magnitude when compensation is performed based on an estimated PCO. Referring to the second graph 932, it may be seen that the tendency of the error magnitude to increase over time has been eliminated compared to the first graph 931. This is because it may be assumed that all signals are received at an antenna phase center (APC) by compensating for the estimated PCO. The APC may correspond to the second point 820 of FIG. 8.

According to an embodiment, the third graph 933 shows the error magnitude based on a signal received after calibration is completed. For example, the third graph 933 may show the error magnitude when compensation is performed based on an estimated PCV model. Referring to the third graph 933, it may be seen that the error magnitude of the third graph 933 is smaller than the error magnitude of the second graph 932 by a magnitude d. This is because even when it is assumed that all signals are received at the APC based on PCO compensation, the error of the second graph 932 still includes an error component according to a reception direction, and after completing compensation based on the PCV model, the error component according to the reception direction is also eliminated, and thus, the error magnitude of the third graph 933 may be reduced by the magnitude d.

While the inventive concept has been particularly shown and described with reference to embodiments thereof, it will be understood that various changes in form and details may be made therein without departing from the spirit and scope of the following claims.

What is claimed is:

1. A method of calibrating a global navigation satellite system (GNSS) antenna, the method comprising:
obtaining GNSS measurement data corresponding to a plurality of directions that correspond to a plurality of respective postures of an electronic device;
generating integration data by combining the GNSS measurement data corresponding to the plurality of directions; and
performing calibration of the GNSS antenna based on the integration data.

2. The method of claim 1, wherein the obtaining of the GNSS measurement data corresponding to the plurality of directions includes:
obtaining first measurement data by receiving signals from a plurality of satellites while a device including the GNSS antenna remains in a first posture; and
obtaining second measurement data by receiving signals from the plurality of satellites while the device including the GNSS antenna remains in a second posture.

3. The method of claim 2, wherein the generating of the integration data includes
identifying satellite positions based on satellite orbit information;
identifying a position of the device including the GNSS antenna on an earth-centered earth fixed frame (ECEF) coordinate system; and
identifying a direction with respect to the device in which a signal is received, based on the identified satellite positions and the identified position of the device.

4. The method of claim 3, wherein the generating of the integration data further includes
obtaining sensing data about the first posture and the second posture;
identifying a first direction in which the signal is incident at a time when the first measurement data is obtained, based on the sensing data and the identified direction in which the signal is received; and
identifying a second direction in which the signal is incident at a time when the second measurement data is obtained, based on the sensing data and the identified direction in which the signal is received,
wherein the plurality of directions include the first direction and the second direction.

5. The method of claim 4, wherein the generating of the integration data further includes
rotating and transforming the first measurement data based on the sensing data so that the first posture matches a reference posture; and
rotating and transforming the second measurement data so that the second posture matches the reference posture; and
generating the integration data by combining the rotated and transformed first measurement data with the rotated and transformed second measurement data.

6. The method of claim 5, wherein the performing of calibration of the GNSS antenna includes
identifying an average position of received signals based on the integration data; and
obtaining a phase center offset (PCO) of the GNSS antenna based on the average position.

7. The method of claim 6, wherein the obtaining of the PCO includes calculating a difference from an antenna reference point of the GNSS antenna to the average position.

8. The method of claim 7, wherein the performing of calibration of the GNSS antenna further includes, after subtracting the PCO from a received signal, obtaining coefficients of a function based on the function for modeling a three-dimensional (3D) structure and storing the coefficients as a phase center variation (PCV) model.

9. An electronic device comprising:
a global navigation satellite system (GNSS) antenna configured to receive satellite signals;
a GNSS module comprising a calibration module configured to perform calibration of the GNSS antenna; and
a sensor module configured to obtain sensing data about a posture of the electronic device,
wherein the calibration module is further configured to:
obtain GNSS measurement data corresponding to a plurality of directions that correspond to a plurality of respective postures of the electronic device;
generate integration data by combining the GNSS measurement data corresponding to the plurality of directions; and
perform calibration of the GNSS antenna based on the integration data.

10. The electronic device of claim 9, wherein the calibration module is further configured to:
obtain first measurement data by receiving signals from a plurality of satellites while the electronic device remains in a first posture; and
obtain second measurement data by receiving signals from the plurality of satellites while the electronic device remains in a second posture.

11. The electronic device of claim 10, wherein the calibration module is further configured to:
identify satellite positions based on satellite orbit information;
identify a position of the electronic device on an earth-centered earth fixed frame (ECEF) coordinate system; and
identify a direction with respect to the electronic device in which a signal is received, based on the identified satellite positions and the identified position of the electronic device.

12. The electronic device of claim 11, wherein the calibration module is further configured to:
obtain sensing data about the first posture and the second posture;
identify a first direction in which the signal is incident at a time when the first measurement data is obtained, based on the sensing data and the identified direction in which the signal is received; and
identify a second direction in which the signal is incident at a time when the second measurement data is obtained, based on the sensing data and the identified direction in which the signal is received, and
the plurality of directions include the first direction and the second direction.

13. The electronic device of claim 12, wherein the calibration module is further configured to:
rotate and transform the first measurement data based on the sensing data so that the first posture matches a reference posture;
rotate and transform the second measurement data so that the second posture matches the reference posture; and
generate the integration data by combining the rotated and transformed first measurement data with the rotated and transformed second measurement data.

14. The electronic device of claim 13, wherein the calibration module is further configured to:
identify an average position of received signals based on the integration data; and
obtain a phase center offset (PCO) of the GNSS antenna based on the average position.

15. The electronic device of claim 14, wherein the PCO is obtained by calculating a difference from an antenna reference point of the GNSS antenna to the average position.

16. The electronic device of claim 15, wherein the calibration module is further configured to, after subtracting the PCO from a received signal, obtain coefficients of a function based on the function for modeling a three-dimensional (3D) structure and store the coefficients as a phase center variation (PCV) model.

17. A method of calibrating a global navigation satellite system (GNSS) antenna, the method comprising:
generating first measurement data by receiving a signal when the antenna is in a posture inclined in a first direction;
generating second measurement data by receiving a signal when the antenna is in a posture inclined in a second direction different from the first direction;
generating integration data by combining the first measurement data with the second measurement data; and
performing calibration of the GNSS antenna based on the integration data.

18. The method of claim 17, wherein the generating of the integration data includes
transforming the first measurement data by converting the first direction into a reference direction;
transforming the second measurement data by converting the second direction into the reference direction; and
merging the transformed first measurement data and the transformed second measurement data.

19. The method of claim 17, wherein the performing of calibration of the GNSS antenna includes
identifying an average position of received signals based on the integration data; and
obtaining a phase center offset (PCO) of the GNSS antenna based on the average position, and
the obtaining of the PCO includes calculating a difference from an antenna reference point of the GNSS antenna to the average position.

20. The method of claim 19, wherein the performing of calibration of the GNSS antenna further includes, after subtracting the PCO from a received signal, obtaining coefficients of a spherical harmonics function based on the spherical harmonics function and storing the coefficients as a phase center variation (PCV) model.
